(19) United States
(12) Patent Application Publication
(10) Pub. No.: US 2018/0359494 A1
(43) Pub. Date: Dec. 13, 2018

(54) METHOD AND APPARATUS OF PREDICTION BINARY TREE STRUCTURE FOR VIDEO AND IMAGE CODING

(71) Applicant: MEDIATEK INC., Hsin-Chu (TW)

(72) Inventors: Chih-Wei HSU, Hsinchu City (TW); Ching-Yeh CHEN, Taipei City (TW)

(21) Appl. No.: 15/780,544

(22) PCT Filed: Dec. 29, 2016
(86) PCT No.: PCT/CN2016/112921

§ 371 Date: May 31, 2018

Related U.S. Application Data
(60) Provisional application No. 62/273,477, filed on Dec. 31, 2015.

(51) Int. Cl. H04N 19/96; H04N 19/176; H04N 19/50; H04N 19/66; H04N 19/124

(52) U.S. Cl. CPC H04N 19/96; H04N 19/176; H04N 19/124; H04N 19/66; H04N 19/50

(57) ABSTRACT

A method and apparatus for partitioning a coding unit into one or more prediction units are disclosed. A prediction binary tree structure corresponding to a binary tree partitioning process for the current block is determined. The current block is partitioned into one or more prediction units according to the prediction binary tree structure. In the encoder side, a prediction process is applied to each prediction unit to generate prediction information for each prediction unit. The prediction information for each prediction unit associated with each prediction unit are encoded into a bitstream for the current block. In the decoder side, each prediction unit is reconstructed based on previous reconstructed data and prediction information of each prediction unit. The prediction information of each prediction unit are derived from the video bitstream. The current block is reconstructed based on the prediction units that are reconstructed according to the prediction binary tree structure derived.

### CROSS REFERENCE TO RELATED APPLICATIONS

The present invention claims priority to U.S. Provisional Patent Application, Ser. No. 62/273,477, filed on Dec. 31, 2015. The present invention is also related to PCT Patent Application, Serial No. PCT/CN2015/096761, filed on Dec. 9, 2015, which claims priority to PCT Patent Application, Serial No. PCT/CN2014/093445, filed on Dec. 10 2014. The U.S. Provisional Patent Application and PCT Patent Applications are hereby incorporated by reference in their entireties.

### TECHNICAL FIELD

The invention relates generally to image and video processing. In particular, the present invention relates to partitioning a coding unit into one or more prediction units using binary tree structure in video and image coding systems.

### BACKGROUND

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC).

In HEVC, one slice is partitioned into multiple coding tree units (CTU). In main profile, the minimum and the maximum sizes of CTU are specified by the syntax elements in the sequence parameter set (SPS). The allowed CTU size can be 8×8, 16×16, 32×32, or 64×64. For each slice, the CTUs within the slice are processed according to a raster scan order.

The CTU is further partitioned into multiple coding units (CU) to adapt to various local characteristics. A quadtree, denoted as the coding tree, is used to partition the CTU into multiple CUs. Let CTU size be 2N×2N, where N is one of the values of 64, 32, or 16. The CTU can be a single CU or can be split into four smaller units of equal sizes (i.e., N×N), which are nodes of coding tree. If units are leaf nodes of coding tree, the units become CUs. Otherwise, the quadtree splitting process can be iterated until the size for a node reaches a minimum allowed CU size as specified in the SPS.

One or more prediction units (PU) are specified for each CU. Coupled with the CU, the PU works as a basic representative block for sharing the prediction process. Inside each PU, the same prediction process is applied and the relevant information is transmitted to the decoder on a PU basis. A CU can be split into one, two or four PUs according to the PU splitting type. HEVC defines eight shapes for splitting a CU into PU as shown in FIG. 1. Unlike the CU, the PU may only be split once. The partitions shown in the second row correspond to asymmetric partitions, where the two partitioned parts have different sizes. In FIG. 1, the upper four partitions are symmetric and the lower four partitions are asymmetric referred as Asymmetric Motion Partitions (AMP).

After obtaining the residual block by applying the prediction process based on the PU splitting type, prediction residues of a CU can be partitioned into transform units (TUs) according to another quadtree structure, which is analogous to the coding tree for the CU. The TU is a basic representative block of residual or transform coefficients for applying the integer transform and quantization. For each TU, one integer transform with the same size is applied to the TU to obtain residual coefficients. These coefficients are transmitted to the decoder after quantization on a TU basis.

The terms, coding tree block (CTB), coding block (CB), prediction block (PB), and transform block (TB) are defined to specify the 2-D sample array of one colour component associated with CTU, CU, PU, and TU, respectively. Thus, a CTU consists of one luma CTB, two chroma CTBs, and associated syntax elements. A similar relationship is valid for CU, PU, and TU.

It is desirable to develop a new tree structure for prediction unit partitioning.

### SUMMARY

A method and apparatus for partitioning a coding unit into one or more prediction units are disclosed. According to the present invention, a prediction binary tree structure corresponding to a prediction binary tree partitioning process for the current block of video data is determined. The current block of video data is partitioned into one or more prediction units according to the prediction binary tree structure. In the encoder side, a prediction process is applied to each prediction unit to generate prediction information for each prediction unit. The prediction information for each prediction unit associated with each prediction unit is encoded into a bitstream for the current block of video data. In the decoder side, each prediction unit is reconstructed based on previous reconstructed data and prediction information of each prediction unit. The prediction information of each prediction unit is derived from the video bitstream. The current block of video data is reconstructed based on the prediction units that are reconstructed according to the prediction binary tree structure derived.

Three partition modes exist for each node of the prediction binary tree structure, where the three partition modes correspond to no-split partition mode, horizontal partition mode which partitions a block into two equal-width partition named left partition and right partition, and vertical partition mode which partitions a block into two equal-height partition named top partition and bottom partition. If one node is split into two new nodes, each new node has the three partition modes again unless the no-split partition mode is selected for the new node or a tree depth limit has been reached at the new node. The tree depth limit is used to constrain the prediction binary tree structure, where the tree depth limit is explicitly signalled at a higher bitstream level than a current block level or implicitly determined using the coding parameters.

A codeword can be signalled for each node to indicate a selected mode among the three partition modes. The codeword may comprise a split flag to indicate whether the node is split or not. When the split flag indicates that the node is split, a direction flag is further used to indicate whether partition direction is horizontal or vertical. The prediction binary tree structure is coded by traversing the prediction binary tree structure recursively by signalling a left node followed by signalling a right node for the horizontal partitions, and/or signalling a top node followed by signalling a bottom node for the vertical partitions.

After the prediction units are determined for the current block of video data, one or more transform units are determined by partitioning the current block of video data using a residual tree structure that is either dependent on or independent of the prediction binary tree structure. For the residual tree structure being independent of the prediction binary tree structure, a residual quad tree structure can be used. For the residual tree structure being dependent on the prediction binary tree structure, a residual binary tree structure can be used. In one embodiment, the residual binary tree structure is set to be the same as the prediction binary tree structure. In another embodiment, the residual binary tree structure is a sub-tree of the prediction binary tree structure or the prediction binary tree structure is a sub-tree of the residual binary tree structure.

### BRIEF DESCRIPTION OF DRAWINGS

FIG. 1 illustrates the eight partition types for splitting a CU (coding unit) into one or more PUs (prediction units) in HEVC (high efficiency video coding).

FIG. 2 illustrates some exemplary prediction binary tree (PBT) partitions according to the present invention.

FIG. 3 illustrates some examples of TU partitions, either independent of or dependent on the prediction binary tree (PBT) partitions of the corresponding CU.

FIG. 4 illustrates a flowchart for an exemplary decoding system incorporating the prediction binary tree (PBT) partitions according to an embodiment of the present invention.

FIG. 5 illustrates a flowchart for an exemplary encoding system incorporating the prediction binary tree (PBT) partitions according to an embodiment of the present invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

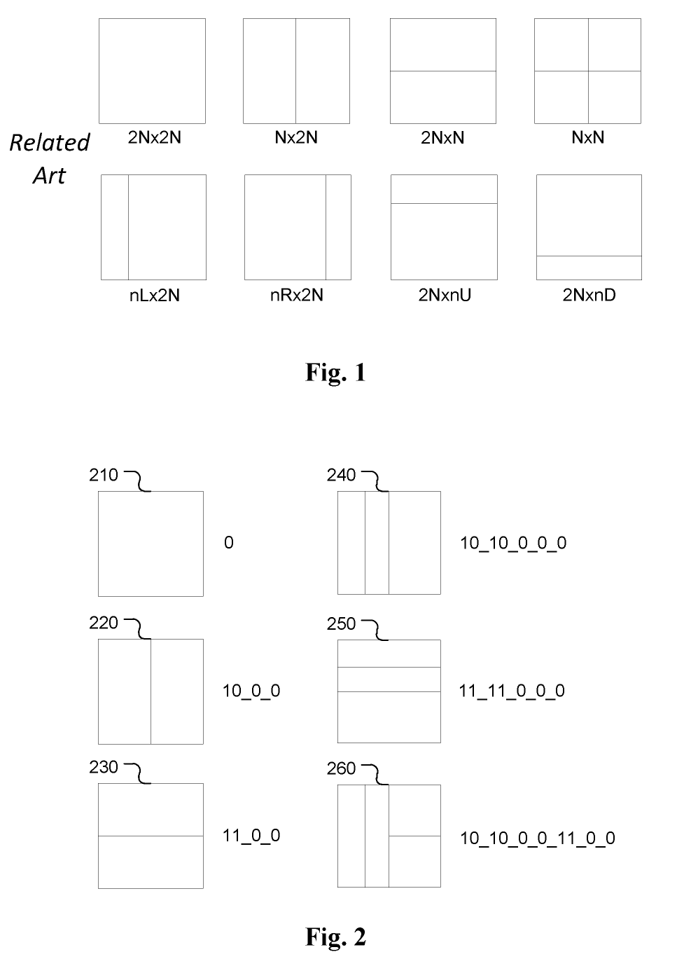

In the convention prediction unit structure, a coding unit is split only once using partition types as shown in FIG. 1, which include symmetric splitting types (binary or quad) as well as asymmetric partition types. The present invention introduces a flexible prediction unit partitioning from a coding unit using a prediction binary tree structure. In Prediction Binary Tree (PBT) partition, a block (e.g. CU) is partitioned either horizontally or vertically in each step. Also, the partition process may decide not to split a block (i.e., no split). The partitioning results can be represented using a binary tree structure (also referred to as the prediction binary tree structure). At each node of binary tree, there are three possible conditions, also named partition modes, corresponding to no-split partition mode, horizontal partition mode and vertical partition mode. For the horizontal partition mode, each block is partitioned horizontally into two partitions (i.e., left and right partitions) with equal width. For the vertical partition mode, each block is partitioned vertically into two partitions (i.e., top and bottom) with equal height. Each new node can be further split using these three modes until the no-split partition mode is selected for this mode or until a specific tree depth being reached. In one example, the specific tree depth is explicitly signalled at a higher bitstream level than a current block level. In another example, the specific tree depth is implicitly determined based on the coding parameters associated with the current block (e.g., the width of height of the current block). The prediction binary tree structure is constrained by the specific tree depth.

In order to signal PBT partitions, the process will traverse the binary tree structure recursively. For each horizontal partition, the left node is signalled first, then the right node is signalled; for each vertical partition, the top node is signalled first, then the bottom node is signalled. In one embodiment, the process will traverse the binary tree structure recursively by signalling the left node first, and then the right node for the horizontal partitions. Afterward, the process will signal the top node first, and then the bottom node for the vertical partitions. The above signalling orders are illustrated as an example. The present invention is not limited to the specific signalling order.

For indicating a selected mode among the three partition modes for each mode, a codeword is signalled. In an embodiment, the codeword comprises a split flag to indicate whether the node is split or not, and further comprises a direction flag to indicate whether the partition direction is horizontal or vertical when the split flag indicates that the node is split. FIG. 2 illustrates some exemplary PBT partitions according to the present invention. In these examples, in each step of partition, a split flag is used, where 0 represents for no split and 1 represents that the block corresponding to a node in the tree structure is further split. When the split flag indicates a split (i.e., split flag equal to 1), a direction flag is further signalled, where 0 represents horizontal partition and 1 represents for vertical partition.

In example 1, partition 210 is compatible with the 2N×2N partition in HEVC. Since there is no further partition at all, only a split flag 0 is signalled.

In example 2, partition 220 is compatible with the N×2N partition in HEVC. In order to represent the partition using PBT, one split flag 1 is coded first and then followed by one direction flag 0 to indicate a horizontal partition. Since there is no further split for the left and right partitions, two more split flags with value 0 are coded.

In example 3, partition 230 is compatible with 2N×N partition in HEVC. In order to represent it using PBT, one split flag 1 is coded first and then followed by one direction flag 1 to indicate a vertical partition. Since there is no further split for the top and bottom partitions, two more split flags with value 0 are coded.

In example 4, partition 240 corresponds to a new partition type that does not exist in HEVC. In order to represent it using PBT, one split flag 1 is coded first and then followed by one direction flag 0 to indicate a horizontal partition. Then, it will code the left partition with depth 1 first. Since the left partition is further split into horizontal partitions, one more split flag 1 and direction flag 0 are signalled. Since there is no further split for the left and right partitions with depth 2, two more split flags with value 0 are coded. Back to the right partition with depth 1, since there is no further split, one split flag 0 is coded.

In example 5, partition 250 corresponds to a new partition type that does not exist in HEVC. In order to represent it using PBT, one split flag 1 is coded first and then followed by one direction flag 1 to indicate the vertical partition. Then it will code the top partition with depth 1 first. Since the top partition is further split into vertical partitions, one more split flag 1 and direction flag 1 are signalled. Since there is no further split for the top and bottom partitions with depth 2, two more split flags with value 0 are coded. Back to the bottom partition with depth 1, since there is no further split, one split flag 0 is coded.

In example 6, partition 260 corresponds to a new partition type that does not exist in HEVC. In order to represent it using PBT, one split flag 1 is coded first and then followed by one direction flag 0 to indicate the horizontal partition. Then it will code the left partition with depth 1 first. Since the left partition is further split into horizontal partitions, one more split flag 1 and direction flag 0 are signalled. Since there is no further split for the left and right partitions with depth 2, two more split flags with value 0 are coded. Back to the right partition with depth 1 that is further split into vertical partitions, one more split flag 1 and direction flag 1 are signalled. Since there is no further split for the top and bottom partitions with depth 2, two more split flags with value 0 are coded.

From the above examples, it is easily observed that PBT can result in more flexible partitions compared with previous standards. The PU partitions in FIG. 2 are just a small number of examples that can be resulted from PBT.

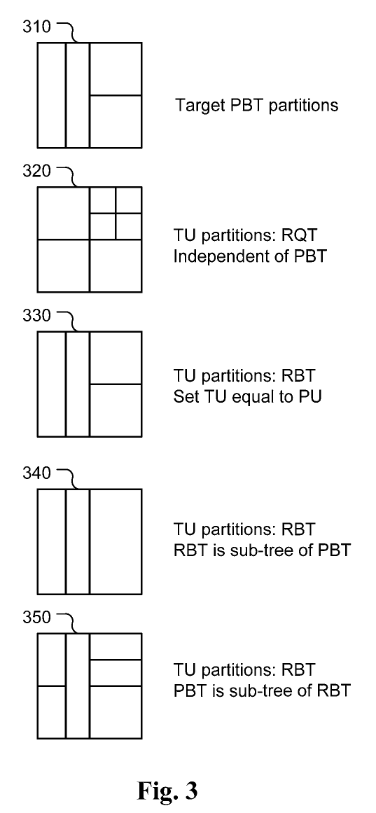

After PBT partitions are determined for one CU, the corresponding Transform Unit (TU) can be determined either independent of or dependent on the PBT partitions of the corresponding CU. For TU partition independent of the PBT partitions of the corresponding CU, TUs can be determined from leaf CU using Residual Quad Tree (RQT) as used in HEVC. If TUs are determined depending on the PBT partitions of the corresponding CU, there are several possible implementations. For TU partition depending on the PBT partitions of the corresponding CU, Residual Binary Tree (RBT) can be used to partition the CU. For TU partition depending on the PBT partitions of the corresponding CU, a simplest way is to set TU equal to PU. Accordingly, the residual coding will follow exactly the same binary tree as PBT. Alternatively, either the RBT can be a sub-tree of PBT or PBT can be a sub-tree of RBT with more codeword required. FIG. 3 illustrates some examples of TU partitions, either independent of or dependent on the PBT partitions of the corresponding CU.

In FIG. 3, partition 310 corresponds to target PU partitions using PBT. Partition 320 corresponds to TU partitions independent of the PBT, where a conventional RQT is used to generate the TUs. Partition 330 corresponds to TU partitions based on the same PBT. Therefore, TUs are equal to PUs. Partition 340 corresponds to TU partitions dependent on the PBT, where the RBT for TUs is a sub-tree of PBT for PUs. In other words, the TU partitions in partition 340 have fewer splits than the PBT as shown in partition 310. Partition 350 corresponds to TU partitions dependent on the PBT, where the PBT for PUs is a sub-tree of RBT for TUs. In other words, the PU partitions in partition 310 have fewer splits than the RBT for TUs as shown in partition 350.

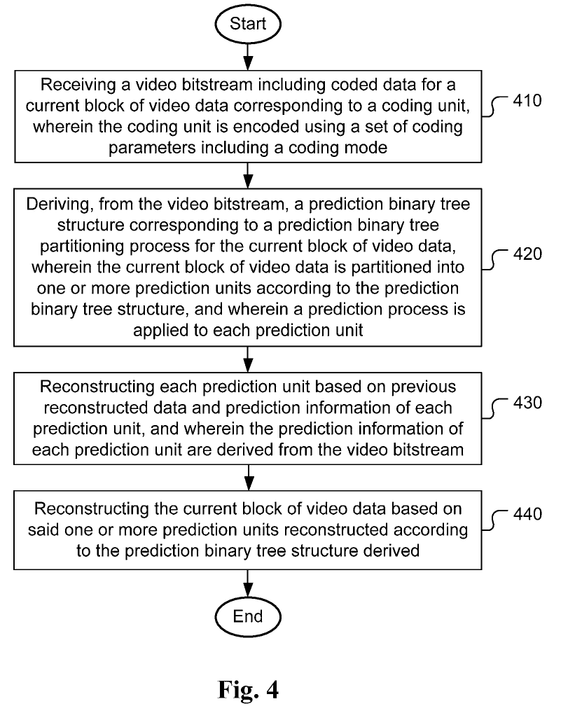

FIG. 4 illustrates a flowchart for an exemplary decoding system incorporating the prediction binary tree (PBT) partitions according to an embodiment of the present invention. According to this method, a video bitstream including coded data for a current block of video data corresponding to a coding unit is received in step 410, where the coding unit is encoded using a set of coding parameters including a coding mode. A prediction binary tree structure corresponding to a prediction binary tree partitioning process is derived from the video bitstream for the current block of video data in step 420, where the current block of video data is partitioned into one or more prediction units according to the prediction binary tree structure, and wherein a prediction process is applied to each prediction unit. Each prediction unit is reconstructed based on previous reconstructed data and prediction information of each prediction unit in step 430, where the prediction information of each prediction unit derived from the video bitstream comprises the prediction mode, side information associated with the prediction mode, and residues, however, the present invention is not limited thereto. The current block of video data is reconstructed based on said one or more prediction units reconstructed according to the prediction binary tree structure derived in step 440.

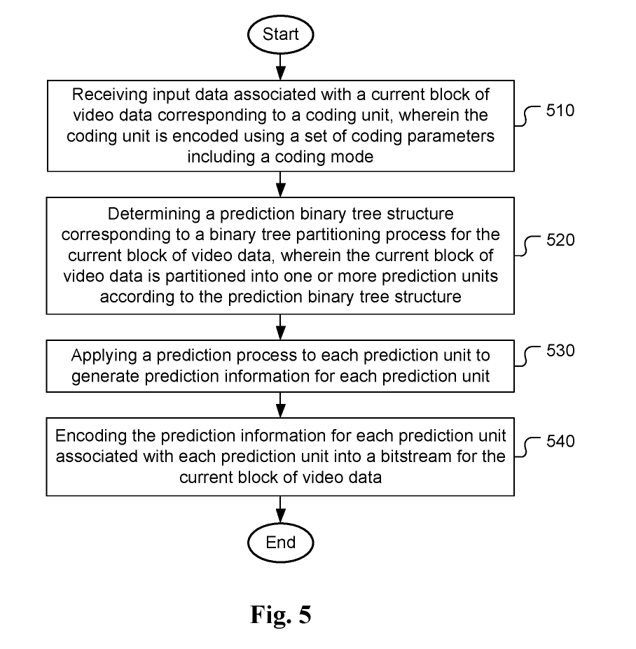

FIG. 5 illustrates a flowchart for an exemplary encoding system incorporating the prediction binary tree (PBT) partitions according to an embodiment of the present invention. Input data associated with a current block of video data corresponding to a coding unit is received in step 510, where the coding unit is encoded using a set of coding parameters including a coding mode. A prediction binary tree structure corresponding to a binary tree partitioning process is determined for the current block of video data in step 520, where the current block of video data is partitioned into one or more prediction units according to the prediction binary tree structure. A prediction process is applied to each prediction unit to generate prediction information for each prediction unit in step 530, in which the prediction information can be the prediction mode, side information associated with the prediction mode, and residues. The prediction information for each prediction unit associated with each prediction unit are encoded into a bitstream for the current block of video data in step 540.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving a video bitstream including coded data for a current block of video data corresponding to a coding unit, wherein the coding unit is encoded using a set of coding parameters including a coding mode;
deriving, from the video bitstream, a prediction binary tree structure corresponding to a prediction binary tree partitioning process for the current block of video data, wherein the current block of video data is partitioned into one or more prediction units according to the prediction binary tree structure, and wherein a prediction process is applied to each prediction unit;
reconstructing each prediction unit based on previous reconstructed data and prediction information of each prediction unit, and wherein the prediction information of each prediction unit are derived from the video bitstream; and
reconstructing the current block of video data based on said one or more prediction units reconstructed according to the prediction binary tree structure derived.

2. The method of claim 1, wherein three partition modes exist for each node of the prediction binary tree structure, wherein the three partition modes correspond to no-split partition mode, horizontal partition mode which partitions a block into two equal-width partition named left partition and right partition, and vertical partition mode which partitions a block into two equal-height partition named top partition and bottom partition.

3. The method of claim 2, wherein if one node is split into two new nodes, each new node has the three partition modes again unless the no-split partition mode is selected for the new node or a tree depth limit is reached at the new node.

4. The method of claim 3, wherein the tree depth limit is used to constrain the prediction binary tree structure, wherein the tree depth limit is explicitly signalled at a higher bitstream level than a current block level or implicitly determined using said set of coding parameters.

5. The method of claim 2, a codeword is signalled for each node to indicate a selected mode among the three partition modes.

6. The method of claim 5, the codeword comprises a split flag to indicate whether the node is split or not.

7. The method of claim 6, when the split flag indicates that the node is split, a direction flag is further used to indicate whether partition direction is horizontal or vertical.

8. The method of claim 7, the prediction binary tree structure is coded by traversing the prediction binary tree structure recursively by signalling a left node followed by signalling a right node for horizontal partitions, and/or signalling a top node followed by signalling a bottom node for vertical partitions.

9. The method of claim 1, wherein after said one or more prediction units are determined for the current block of video data, one or more transform units are determined by partitioning the current block of video data using a residual tree structure.

10. The method of claim 9, wherein the residual tree structure is independent of the prediction binary tree structure and the residual tree structure corresponds to a residual quad tree structure.

11. The method of claim 9, wherein the residual tree structure is dependent on the prediction binary tree structure and the residual tree structure corresponds to a residual binary tree structure.

12. The method of claim 11, wherein the residual binary tree structure is set to be the same as the prediction binary tree structure.

13. (canceled)

14. An apparatus for video decoding, the apparatus comprising one or more electronic circuits or processors arrange to:
receive a video bitstream including coded data for a current block of video data corresponding to a coding unit, wherein the coding unit is encoded using a set of coding parameters including a coding mode;
derive, from the video bitstream, a prediction binary tree structure corresponding to a prediction binary tree partitioning process for the current block of video data, wherein the prediction binary tree structure represents partitioning the current block of video data into one or more prediction units, and wherein a prediction process is applied to each prediction unit;
reconstruct each prediction unit based on previous reconstructed data and prediction information of each prediction unit derived from the video bitstream; and
reconstruct the current block of video data based on said one or more prediction units reconstructed according to the prediction binary tree structure derived.

15. A method of video encoding, the method comprising:
receiving input data associated with a current block of video data corresponding to a coding unit, wherein the coding unit is encoded using a set of coding parameters including a coding mode;
determining a prediction binary tree structure corresponding to a prediction binary tree partitioning process for the current block of video data, wherein the current block of video data is partitioned into one or more prediction units according to the prediction binary tree structure;
applying a prediction process to each prediction unit to generate prediction information for each prediction unit; and
encoding the prediction information for each prediction unit associated with each prediction unit into a bitstream for the current block of video data.

16. The method of claim 15, wherein three partition modes exist for each node of the prediction binary tree structure, wherein the three partition modes correspond to no-split partition mode, horizontal partition mode which partitions a block into two equal-width partition named left partition and right partition, and vertical partition mode which partitions a block into two equal-height partition named top partition and bottom partition.

17. The method of claim 16, wherein if one node is split into two new nodes, each new node has the three partition modes again unless the no-split partition mode is selected for the new node or a tree depth limit is reached at the new node.

18. The method of claim 17, wherein the tree depth limit is used to constrain the prediction binary tree structure, wherein the tree depth limit is explicitly signalled at a higher bitstream level than a current block level or implicitly determined using said set of coding parameters.

19. The method of claim 16, a codeword is signalled for each node to indicate a selected mode among the three partition modes.

20. The method of claim 19, the codeword comprises a split flag to indicate whether the node is split or not.

21. (canceled)

22. (canceled)

23. (canceled)

24. An apparatus for video encoding, the apparatus comprising one or electronic circuits or processors arranged to:
receive input data associated with a current block of video data corresponding to a coding unit, wherein the coding unit is encoded using a set of coding parameters including a coding mode;
determine a prediction binary tree structure corresponding to a prediction binary tree partitioning process for the current block of video data, wherein the prediction binary tree structure represents partitioning the current block of video data into one or more prediction units, and wherein a prediction process is applied to each prediction unit;
apply a prediction process to each prediction unit to generate prediction information for each prediction unit; and
encode the prediction information for each prediction unit associated with each prediction unit into a bitstream for the current block of video data.
